(19) United States
(12) Patent Application Publication
(10) Pub. No.: US 2010/0099805 A1
(43) Pub. Date: Apr. 22, 2010

(54) Polymerization-curable composition, method for polymerization curing thereof, and polymerization-cured resin composition

(75) Inventors: Hiroyuki Okuhira, Kariya-city (JP); Masashi Kitsuneduka, Kariya-city (JP); Akio Sugiura, Kariya-city (JP); Kazuo Kato, Nagoya-city (JP); Noriya Hayashi, Tokyo (JP); Hiroshi Mizuno, Tokyo (JP)

Correspondence Address: HARNESS, DICKEY & PIERCE, P.L.C., P.O. BOX 828, BLOOMFIELD HILLS, MI, 48303, US

(73) Assignees: DENSO CORPORATION, Kariya-city (JP); Mitsubishi Heavy Industries, Ltd., Tokyo (JP)

(21) Appl. No.: 12/587,888

(22) Filed: Oct. 14, 2009

(30) Foreign Application Priority Data
Oct. 16, 2008 (JP) 2008-267692
Oct. 7, 2009 (JP) 2009-233840

(51) Int. Cl. C08G 65/04; C08F 16/12; C08F 4/69; C08G 77/00; C08F 124/00; C08K 5/54

(52) U.S. Cl. 524/261; 528/421; 528/417; 526/332; 526/222; 528/10; 526/273; 526/266; 524/543; 524/612

(57) ABSTRACT

The present invention provides a polymerization-curable composition comprising at least one kind of a cationically polymerizable compound having in the molecule at least one cationically polymerizable functional group selected from the group consisting of an alicyclic epoxy group, a vinylether group and an oxetane group, and at least one kind of a thermally latent polymerization initiator, characterized in that the polymerization-curable composition is allowed to undergo an exothermic polymerization reaction by applying primary thermal energy to a portion of the polymerization-curable composition, and then the entire polymerization-curable composition is polymerization-cured by secondary thermal energy generated as a result of the exothermic polymerization reaction; a method for polymerization-curing thereof; and a polymerization-cured resin composition.

### TECHNICAL FIELD

The present invention relates to a polymerization-curable composition comprising a cationically polymerizable compound having an alicyclic epoxy group, a vinylether group or an oxetane group, and a thermally latent polymerization initiator; a method for polymerization-curing the polymerization-curable composition; and a polymerization-cured resin composition obtained by the method for polymerization-curing thereof.

### BACKGROUND ART

A heat-curable resin composition typified by an epoxy resin is used in various fields and applications, consisting mainly of electric appliances and automobiles. While a curing furnace is required for curing of the heat-curable resin composition, there is a need to improve a curing method, which leads to release of a large amount of CO₂, from the viewpoint of environmental protection. One of the improved curing methods includes, for example, a method of curing with energy rays in a short time, such as UV curing, EB curing or the like. However, such a method had the following problems, i.e. only a portion irradiated with energy rays or the close proximity of the portion is cured. Also, when used as a thick cured layer or for the portion sandwiched between adhesive materials such as an adhesive, energy rays do not reach it, and thus defective curing occurs or it becomes impossible to cure.

Japanese Unexamined Patent Publication No. 7-507836 proposes a curing system in which primary curing by UV irradiation and secondary curing by the subsequent heating are combined. However, such a curing system was insufficient in measures for protecting the environment, since the curing system includes a special curing furnace.

In contrast, Japanese Unexamined Patent Publication No. 11-193322 and Japanese Unexamined Patent Publication No. 2001-2760 disclose unique techniques in which first curing is caused by UV irradiation, and reaction heat generated upon curing is used for an exothermal reaction of another portion, and also the exothermic reaction proceeds successively as a chain reaction, and thus a heat-curing furnace is not required. This is a curing system using cationic polymerization. However, since the curing system is one in which the first reaction and the subsequent chain reaction are allowed to proceed by different energy, reaction initiators corresponding to each reaction system, i.e. two kinds of a reaction initiator for UV curing and a reaction initiator for heat-curing are required, and also there was a problem such as complexity during blending of them.

It was a known curing technique to use a method in which curing with UV irradiation without using heat is used, or curing is allowed to proceed by gradually raising a temperature from a low temperature of less than 100° C. for the purpose of preventing a runaway reaction when heat is used from the beginning, since a cationic polymerization reaction has high reactivity. In the case of using curing with UV irradiation without using heat, curing of a UV-curable resin is inhibited by oxygen in a radical reaction system, and thus there arises a problem in that internal defective curing occurs in a thick film system. When heat is used from the beginning, there arises a problem in that a long time is required, since curing is allowed to proceed by gradually raising the temperature from a low temperature.

### SUMMARY OF INVENTIONS

The present invention has been made in light of these conventional problems, and an object thereof is to provide a polymerization-curing method which uses heat from the beginning and does not require a long time, in which only a reaction initiator for heat-curing is used, and curing of a UV-curable resin is not inhibited by oxygen like in a radical reaction system; a polymerization-curable composition suited for the method for polymerization-curing thereof; and a polymerization-cured resin composition obtained by the method for polymerization-curing thereof.

According to the present invention, an excellent thermal chain polymerization curing system was found, which can control the rate of a polymerization curing reaction within a preferred range, in which an entire polymerization-curable composition is polymerization-cured by secondary thermal energy generated by an exothermic polymerization reaction occurring in a polymerization-curable composition, by mixing only a thermal latent polymerization initiator as a thermocuring reaction initiator into the composition, and applying primary thermal energy, as thermal energy to be applied from the beginning, to only a portion of the thermal polymerization-curable composition, when the polymerization-curable composition containing a cationically polymerizable compound having a cationically polymerizable functional group such as an alicyclic epoxy group, a vinylether group, an oxetane group or the like is polymerization-cured by using heat from the beginning.

According to the present invention, it was found that it is possible to accurately control the rate of a polymerization curing reaction within a preferred range by optionally adjusting the concentration of a cationically polymerizable functional group within a specific range, and controlling the amount of primary thermal energy to be applied to a polymerization-curable composition through control of the temperature of the composition, and that a polymerization-cured resin composition, in which hard and brittle properties as drawbacks of a conventional epoxy curing system are reduced, and flexible property is increased, can be advantageously obtained, while maintaining thermal chain polymerization curability by using a cationically polymerizable compound having a functional group of chemical equivalents within a specific range, and further blending a filler having a specific thermal conductivity.

As described in claim 1, the polymerization-curable composition according to the first aspect of the present invention comprises at least one kind of a cationically polymerizable compound having in the molecule at least one cationically polymerizable functional group selected from the group consisting of an alicyclic epoxy group, a vinylether group and an oxetane group, and at least one kind of a thermally latent polymerization initiator, characterized in that the polymerization-curable composition is allowed to undergo an exothermic polymerization reaction by applying primary thermal energy to a portion of the polymerization-curable composition, and then the entire polymerization-curable composition is polymerization-cured by secondary thermal energy generated as a result of the exothermic polymerization reaction.

The polymerization-curable composition according to the first aspect of the present invention comprises a specific cationically polymerizable compound and a specific thermally latent polymerization initiator described above, and the polymerization-curable composition is allowed to undergo an exothermic polymerization reaction by applying primary thermal energy to a portion of the polymerization-curable composition, and then the entire polymerization-curable composition is polymerization-cured by secondary thermal energy generated as a result of the exothermic polymerization reaction. Thus, it becomes possible to perform polymerization-curing in a short time while controlling the rate of a polymerization curing reaction within a preferred range, without using two kinds of a reaction initiator for UV curing and a reaction initiator for heat-curing.

As described in claim 17, the method for polymerization-curing a polymerization-curable composition comprises supplying a polymerization-curable composition comprising at least one kind of a cationically polymerizable compound having in the molecule at least one cationically polymerizable functional group selected from the group consisting of an alicyclic epoxy group, a vinylether group and an oxetane group, and at least one kind of a thermally latent polymerization initiator; applying primary thermal energy to a portion of the polymerization-curable composition, thereby causing an exothermic polymerization reaction in the polymerization-curable composition; and polymerization-curing the entire polymerization-curable composition by secondary thermal energy generated as a result of the exothermic polymerization reaction.

Similar to the above first aspect of the present invention, according to the method for polymerization-curing a polymerization-curable composition according to the second aspect of the present invention, it is possible to perform polymerization-curing in a short time while controlling the rate of a polymerization curing reaction within a preferred range, without using two kinds of a reaction initiator for UV curing and a reaction initiator for heat-curing.

As described in claim 18, the polymerization-cured resin composition according to the third aspect of the present invention is obtained by supplying a polymerization-curable composition comprising at least one kind of a cationically polymerizable compound having in the molecule at least one cationically polymerizable functional group selected from the group consisting of an alicyclic epoxy group, a vinylether group and an oxetane group, and at least one kind of a thermally latent polymerization initiator; applying primary thermal energy to a portion of the polymerization-curable composition, thereby causing an exothermic polymerization reaction in the polymerization-curable composition; and polymerization-curing the entire polymerization-curable composition by secondary thermal energy generated as a result of the exothermic polymerization reaction.

Similar to the above first aspect of the present invention, the polymerization-cured resin composition according to the third aspect of the present invention can be obtained by performing polymerization curing in a short time while controlling the rate of a polymerization curing reaction within a preferred range, without using two kinds of a reaction initiator for UV curing and a reaction initiator for heat-curing.

### DETAILED DESCRIPTION

The preferred embodiment of the polymerization-curable composition according to the above first aspect includes a polymerization-curable composition in which the primary thermal energy is applied to 10% by mass or less of the entire polymerization-curable composition, thereby allowing the composition to undergo an exothermic polymerization reaction, and thus the entire composition is polymerization-cured by secondary thermal energy generated by the exothermic polymerization reaction. It is preferred that the primary thermal energy not be applied to more than 10% by mass of the entire polymerization-curable composition, since it becomes difficult to control the rate of a polymerization curing reaction within a satisfactory range and in order to prevent runaway of the polymerization curing reaction.

The phrase “10% by mass or less of the entire polymerization-curable composition” means that 10% by mass or less on average of the entire molding of the polymerization-curable composition, and more specifically means that when the polymerization-curable composition is in the state of a film, 10% by mass or less on average of the entire thickness of the entire surface of the film. When the polymerization-curable composition is sandwiched between adherents, the above phrase means “10% by mass or less on average of the entire deepness of the polymerization-curable composition in a sandwiched state. In order to perform polymerization curing more accurately in a short time by controlling the rate of the polymerization curing reaction within a satisfactory range, the primary thermal energy is more preferably applied to 3% by mass or more of the entire polymerization-curable composition, and particularly preferably 4% to 9% by mass of the entire polymerization-curable composition.

The polymerization curing time when primary thermal energy is applied, thereby allowing the polymerization-curable composition to undergo an exothermic polymerization reaction, and thus the entire composition is polymerization-cured by secondary thermal energy generated by the exothermic polymerization reaction is preferably considerably shorter than a polymerization curing time using a conventional heating furnace. The time required for proceeding of curing is 10 minutes or less, more preferably 0.5 to 10 minutes, and particularly preferably 1 to 5 minutes.

Another preferred embodiment of the polymerization-curable composition according to the above first aspect includes a polymerization-curable composition in which the primary thermal energy is applied by heating the polymerization-curable composition to a temperature within a range from 100° C. to 400° C., thereby allowing the composition to undergo an exothermic polymerization reaction, and thus the entire composition is polymerization-cured by secondary thermal energy generated by the exothermic polymerization reaction.

Still another preferred embodiment of the polymerization-curable composition according to the above first aspect includes a polymerization-curable composition in which the primary thermal energy is applied by heating the polymerization-curable composition to a temperature within a range from 150° C. to 350° C., thereby allowing the composition to undergo an exothermic polymerization reaction, and thus the entire composition is polymerization-cured by secondary thermal energy generated by the exothermic polymerization reaction.

As described above, the amount of primary thermal energy to be applied to the polymerization-curable composition is preferably adjusted by controlling the temperature of the composition. More specifically, the temperature of the polymerization-curable composition is preferably adjusted within a predetermined range by heating means due to direct application using hot wires such as soldering iron, or indirect application using laser, infrared rays, high frequency induction heating or the like. When the temperature of the polymerization-curable composition is lower than 100° C., the amount of secondary thermal energy generated by the exothermic polymerization reaction is insufficient, and it is difficult to perform a polymerization curing treatment in a short time. It is not preferable that the temperature of the polymerization-curable composition is higher than 400° C., since the amount of secondary thermal energy generated by the exothermic polymerization reaction becomes too large, and runaway of the polymerization curing reaction is likely to occur. Therefore, the temperature of the polymerization-curable composition is preferably from 120° C. to 350° C., and particularly preferably from 100° C. to 300° C.

As “at least one kind of a cationically polymerizable compound having at least one cationically polymerizable functional group selected from the group consisting of an alicyclic epoxy group, a vinylether group and an oxetane group” in the polymerization-curable composition according to the above first aspect, for example, at least one kind of a cationically polymerizable compound having at least one, preferably two or more, more preferably from two to ten, and particularly preferably from two to five “cationically polymerizable functional groups selected from the group consisting of an alicyclic epoxy group, a vinylether group and an oxetane group” is selected within at least one kind, and preferably one to five kinds, according to the applications of the objective polymerization-cured resin composition.

Yet another preferred embodiment of the polymerization-curable composition according to the above first aspect includes a polymerization-curable composition in which at least one kind of a cationically polymerizable compound has at least one alicyclic epoxy group. Specific examples of the alicyclic epoxy group include an epoxycyclobutane ring, epoxycyclopentane ring, epoxycyclohexane ring, epoxycycloheptane ring, epoxycyclooctane ring and the like. More specifically, difunctional type compounds having the alicyclic epoxy group, such as CELOXIDE 2021P (3,4-epoxycyclohexylmethyl-3,4-epoxycyclohexane carboxylate), CELOXIDE 2081, CELOXIDE 3000 and the like; monofunctional type compounds such as CELOXIDE 2000 and the like; and polyfunctional type compounds such as EPOLEAD GT301, EPOLEAD GT401 and the like manufactured by DAICEL CHEMICAL INDUSTRIES, LTD. are exemplified. Of these alicyclic epoxy groups, an epoxycyclohexane ring is preferred. More specifically, CELOXIDE 2021P, CELOXIDE 2081, EPOLEAD GT301, etc., each having the epoxycyclohexane ring, are preferred, and CELOXIDE 2021P, CELOXIDE 2081, etc. are particularly preferred from a viewpoint of high reactivity, good balance between stability upon storage and reactivity upon curing, and availability of a general-purpose material.

The “cationically polymerizable functional group” in the polymerization-curable composition according to the above first aspect may be a “vinylether group”, and specific examples of the vinylether group include alkyl vinyl ethers such as butyl vinyl ether, propyl vinyl ether, 2-ethylhexyl vinyl ether and the like; and vinylether attached to a cyclic compound such as cyclohexyl vinyl ether. More specifically, monofunctional type compounds having the vinylether group, such as EHVE (2-ethylhexyl vinyl ether), CHVE (cyclohexyl vinyl ether), HBVE (hydroxybutyl vinyl ether), CHMVE (cyclohexanedimethanol monovinyl ether) and the like; difunctional type compounds such as BDVE (butanediol divinyl ether), CHDVE (cyclohexanedimethanol divinyl ether), TEGVE (triethylene glycol divinyl ether) and the like; and polyfunctional type compounds such as TMPVE (trimethylolpropane trivinyl ether), PEVE (pentaerythritol tetravinyl ether) and the like manufactured by NIPPON CARBIDE INDUSTRIES CO., INC. are exemplified. Of these vinylether groups, 2-ethylhexyl vinyl ether and cyclohexyl vinyl ether are preferred. More specifically, EHVE, CHDVE, TEGVE, etc., each having the vinylether group, are preferred from a viewpoint of comparatively high boiling point and high reactivity.

The “cationically polymerizable functional group” in the polymerization-curable composition according to the above first aspect may be an “oxetane group”, and specific examples of the oxetane group include 3-ethyl-3-alkyloxetane group, 3-ethyl-3-oxyalkyloxetane group, 2-ethylhexyloxetane group, xylyleneoxetane group and the like. More specifically, monofunctional type compounds such as OXT-101 (3-ethyl-3-hydroxymethyloxetane) (oxetane alcohol), OXT-212 (2-ethylhexyloxetane), etc., and OXT-121 (xylenebisoxetane), OXT-221 (3-ethyl-3(((3-ethyloxetan-3-yl)methoxy)methyl)oxetane), etc., each having the oxetane group, manufactured by TOAGOSEI CO., LTD. are exemplified. Of these oxetane groups, a 3-methyl-3-oxyalkyoxetane group and the like are preferred. More specifically, OXT-121 and the like are preferred from a point view of small curing shrinkage, and OXT-212 is preferred from a point view of high reactivity.

Yet another preferred embodiment of the polymerization-curable composition according to the above first aspect includes a polymerization-curable composition in which the concentration of the cationically polymerizable functional group is 0.5 mmol/g or more based on the entire polymerization-curable composition as the conditions of a chain reaction. The concentration of the cationically polymerizable functional group is more preferably 1 mmol/g or more, still more preferably from 2 mmol/g to 15 mmol/g, and particularly preferably from 5 mmol/g to 12 mmol/g.

As “at least one kind of a thermally latent polymerization initiator” in the polymerization-curable composition according to the above first aspect, one kind of thermally latent polymerization initiator is usually used, and two or more kinds of thermally latent polymerization initiators may also be optionally used. As used herein, the thermally latent polymerization initiator refers to a compound having a portion which is activated by heat, i.e. a compound which is activated as a result of dissociation of a protecting group by heat, and thus acts as an initiator. The thermally latent polymerization initiator may be used alone, or two or more kinds of them may be optionally used in combination. Usually, one kind of a thermally latent polymerization initiator is used. Examples of the thermally latent polymerization initiator include binary or higher polymerization initiators containing at least one kind of a sulfonium salt represented by the general formula (I) (II), (II′), (III), (IV), (V), (VI) or (VII) shown below. Of these sulfonium salts, a sulfonium salt containing SbF₆ or PF₆ as anion species is preferred from a point view of high reactivity, and a sulfonium salt containing SbF₆ as anion species is particularly preferred from a point view of high activity.

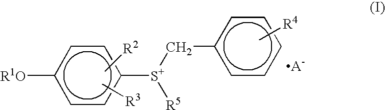

(wherein R¹ represents hydrogen, a methyl group, an acetyl group or a methoxycarbonyl group, R² and R³ independently represent hydrogen, halogen or a C₁-C₄ alkyl group, R⁴ represents hydrogen, halogen or a methoxy group, R⁵ represents a C₁-C₄ alkyl group, and A represents SbF₆, PF₆, AsF₆ or BF₄).

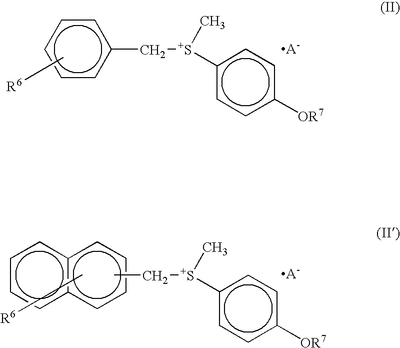

(wherein, in the formula (II) or (II′), R⁶ represents a hydrogen atom, a halogen atom, a nitro group or a methyl group; R⁷ represents a hydrogen atom, CH₃CO or CH₃OCO, and A represents SbF₆, PF₆, BF₆ or AsF₆).

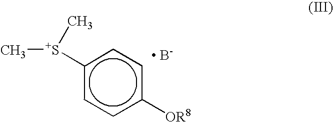

(wherein R⁸ represents a hydrogen atom, CH₃CO or CH₃OCO, and B represents SbF₈, PF₆, BF₈, AsF₈ or CH₃SO₄).

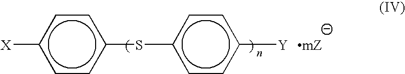

In the formula (IV), X represents a sulfonio group represented by the general formula:

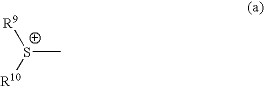

(wherein, in the formula (a), R⁹ represents a C₁-C₁₈ aliphatic group; R¹⁰ represents a C₁-C₁₈ aliphatic group or a C₈-C₁₈ substituted or non-substituted aromatic group, and R⁹ and R¹⁰ may be combined with each other to form a ring), and in the formula (IV), Y represents a sulfonio group represented by the general formula:

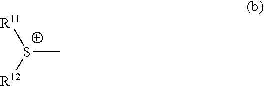

(wherein, in the formula (b), R¹¹ represents a C₁-C₁₈ aliphatic group, R¹² represents a C₁-C₁₈ aliphatic group or a C₈-C₁₈ substituted or non-substituted aromatic group, and R¹¹ and R¹² may be combined with each other to form a ring), or a hydrogen atom, a halogen atom, a nitro group, an alkoxy group, a C₁-C₁₈ aliphatic group or a C₆-C₁₈ substituted or non-substituted phenyl group, a phenoxy group or a thiophenoxy group. In the formula (IV), n and m each independently represent an integer of 1 to 2, and Z represents an anion represented by the formula MQ₁ or MQ₁₋₁OH (M represents B, P, As or Sb, Q represents a halogen atom, and l represents an integer of 4 or 6).

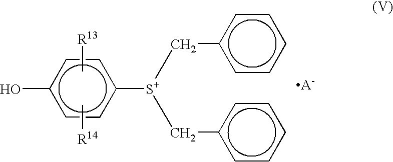

(wherein R¹³ and R¹⁴ independently represent hydrogen or any one of a C₁-C₄ alkyl group, and A represents SbF₆, PF₆ or AsF₆).

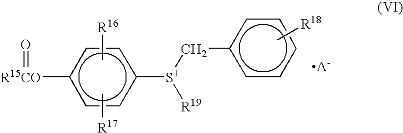

(wherein R¹⁵ represents an ethoxy group, a phenyl group, a phenoxy group, a benzyloxy group, a chloromethyl group, a dichloromethyl group, a trichloromethyl group or a trifluoromethyl group, R¹⁶ and R¹⁷ independently represent hydrogen, halogen or a C₁-C₄ alkyl group, R¹⁸ represents hydrogen, a methyl group, a methoxy group or halogen, R¹⁹ represents hydrogen, a methyl group, a methoxy group or halogen, and A represents SbF₆, PF₆, BF₄ or AsF₆).

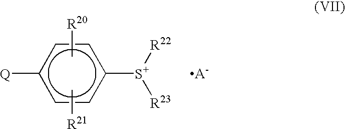

(wherein Q represents a methoxycarbonyloxy group, an acetoxy group, a benzyloxycarbonyloxy group or a dimethylamine group, R²⁰ and R²¹ independently represent hydrogen or any one of a C₁-C₄ alkyl group, R²² and R²³ independently represent hydrogen or any one of a C₁-C₄ alkyl group, and A represents SbF₆, PF₆, AsF₆ or BF₄).

Yet another preferred embodiment of the polymerization-curable composition according to the above first aspect includes a polymerization-curable composition in which at least one kind of a thermally latent polymerization initiator is a sulfonium salt of SbF₆ or PF₆. Specific examples of the sulfonium salt as at least one kind of the thermally latent polymerization initiator include SI series such as SI-45L, SI-60L, SI-80L, SI-100L, SI-110L, SI-150L, SI-145L, 150 and 160 manufactured by SANSHIN CHEMICAL INDUSTRY CO., LTD.; and ADEKAOPTON CP-77 and CP-66 manufactured by ADEKA CORPORATION. Of these, SI-60L and CP-77 are preferred because of high activity.

Yet another preferred embodiment of the polymerization-curable composition according to the above first aspect includes a polymerization-curable composition in which the additive amount of at least one kind of the thermally latent polymerization initiator is from 0.1% by mass to 5% by mass in terms of the solid content based on the entire polymerization-curable composition. As used herein, the additive amount of the thermally latent polymerization initiator in terms of the solid content means an additive amount of only the thermally latent polymerization initiator among the thermally latent polymerization initiator which is usually available in a state of being dissolved in a solution, more specifically the total solid content of the initiator based on the entire components relating to the polymerization reaction, excluding fillers, additives, solvents and the like. The thermally latent polymerization initiator is often in the form of solid and is usually mixed with the above cationically polymerizable compound in a state of being dissolved in a solution in the concentration of 10 to 30% by weight.

In this embodiment, the additive amount of at least one kind of the thermally latent polymerization initiator is from 0.1% by mass to 5% by mass, preferably from 0.2% by mass to 4% by mass, and particularly preferably from 0.5% by mass to 3% by mass, in terms of the solid content based on the entire polymerization-curable composition. The additive amount in terms of the solid content is not preferably 0.1% by mass or less, since sufficient heat required for a chain reaction is not obtained, and thus the chain reaction does not proceed. The additive amount in terms of the solid content is not preferably 0.5% by mass or more, since the physical properties of a cured article deteriorate, and thus storage stability becomes inferior.

Yet another preferred embodiment of the polymerization-curable composition according to the above first aspect includes a polymerization-curable composition in which the chemical equivalent of the cationically polymerizable functional group is 200 g/mol or more and 20,000 g/mol or less. As used herein, the chemical equivalent of the cationically polymerizable functional group means a weight per one cationically polymerizable functional group to be used, that is, a weight per one cationically polymerizable functional group obtained by dividing a molecular weight of the cationically polymerizable compound by the number of cationically polymerizable functional groups contained in the cationically polymerizable compound. The chemical equivalent of the cationically polymerizable functional group is not preferably 200 g/mol or less, since reactivity is too high and runway of the polymerization occurs, and it is dangerous, and also sufficient flexibility cannot be imparted, and a cured article becomes hard and brittle. The chemical equivalent of the cationically polymerizable functional group is not preferably 20,000 g/mol or more, since sufficient heat required for a chain reaction is not obtained, and thus reactivity decreases.

In such an embodiment, more preferred embodiment, which can impart flexibility and also can maintain a chain reaction, includes a polymerization-curable composition in which the chemical equivalent of the cationically polymerizable functional group is 300 g/mol or more and 10,000 g/mol or less. The chemical equivalent of the cationically polymerizable functional group is particularly preferably 300 g/mol or more and 8,000 g/mol or less.

Yet another preferred embodiment of the polymerization-curable composition according to the above first aspect includes a polymerization-curable composition in which at least one of the cationically polymerizable compounds has a structural skeleton derived from a polyether, silicone, castor oil or polybutadiene. The cationically polymerizable compound having such a skeleton is preferred, since it has a high structural skeleton and can impart sufficient flexibility to a cured article, and is also excellent in heat resistance and moisture heat resistance. The polyether, castor oil and polybutadiene are particularly preferred, since they are excellent in compatibility with the cationically polymerizable compound.

Specific examples of the cationically polymerizable compound having a structural skeleton derived from the polyether include compounds which have a polyalkylene glycol such as polyethylene glycol, polypropylene glycol (PPG), polybutylene glycol, PTMEG, PTXG or the like as a main skeleton, and also have a cationically polymerizable group at the terminal or inside. These compounds can be obtained by adding diisocyanate to a polyether having a hydroxyl group in a skeleton to obtain a urethane prepolymer, and reacting a hydroxyl group of a cationically polymerizable compound having a hydroxyl group with an isocyanate group of the urethane prepolymer.

Specific examples of the cationically polymerizable compound having a structural skeleton derived from the silicone include compounds having dimethylsilicone, phenylmethylsilicone or the like in the skeleton. These compounds can be obtained by adding a diisocyanate compound to a carbinol-terminated silicone to obtain an isocyanate-terminated silicone, and reacting a hydroxyl group of a cationically polymerizable compound having a hydroxyl group with a terminal isocyanate of the silicone.

Specific examples of the cationically polymerizable compound having a structural skeleton derived from the castor oil include modified polyols obtained from castor oil as a material in which an aromatic ring such as bisphenol can be introduced so as to improve physical properties and compatibility. These polyols can be obtained by adding a diisocyanate compound to a hydroxyl group-terminated castor oil to obtain an isocyanate-terminated castor oil, and reacting a hydroxyl group of a cationically polymerizable compound having a hydroxyl group with a terminal isocyanate of the castor oil.

Specific examples of the cationically polymerizable compound having a structural skeleton derived from the polybutadiene include EPOLEAD PB as polybutadiene having an epoxy group manufactured by DAICEL CHEMICAL INDUSTRIES, and compounds obtained by epoxidation, oxetanation or vinyl etherification of a terminal of polybutadienepolyol manufactured by Idemitsu Kosan Co., Ltd. These compounds can be obtained by adding a diisocyanate compound to a hydroxyl group-terminated polybutadiene to obtain an isocyanate-terminated polybutadiene, and reacting a hydroxyl group of a cationically polymerizable compound having a hydroxyl group with a terminal isocyanate of the polybutadiene.

A compound having a high-polarity structure such as polyester, polycarbonate or the like can be used, as long as functional equivalents are within the above range.

Yet another preferred embodiment of the polymerization-curable composition according to the above first aspect includes a polymerization-curable composition, further comprising a filler, and the content of the filler is preferably from 5 to 500% by mass based on the polymerization-curable composition. The filler is used for the purpose of reinforcement, softening, decrease in linear expansion, control of thermal conductivity and improvement in physical properties, and also can be selected according to applications of the objective polymerization-cured resin composition. Specific examples thereof include organic compounds and inorganic compounds.

The content of the filler is not preferably 5% by mass or less, based on the polymerization-curable composition, since the effect of the filler is less likely to be obtained. The content of the filler is not preferably 500% by mass or more based on the polymerization-curable composition, since viscosity increases and thus workability drastically decreases.

Yet another preferred embodiment of the polymerization-curable composition according to the above first aspect includes a polymerization-curable composition in which the filler has a thermal conductivity of 1 W/mK or less. The thermal conductivity of the filler is not preferably more than 1 W/mK, since heat generated during the reaction is merely radiated by the filler and thus it becomes impossible to use for the subsequent reaction for a chain reaction.

In such an embodiment, a composition containing the filler having a thermal conductivity of 0.5 W/mK or less is preferred from a viewpoint of low heat radiation effect of reaction heat due to the filler. The thermal conductivity of the filler is more preferably 0.3 W/mK or less, and particularly preferably 0.2 W/mK or less.

Yet another preferred embodiment of the polymerization-curable composition according to the above first aspect includes a polymerization-curable composition in which the filler is an organic compound. The filler is particularly preferably an organic compound from a viewpoint of the flexibility imparting effect due to the filler, low thermal conductivity and low heat radiation amount. Specific examples of the organic compound include those in which a base resin is a silicone, urethane or acrylic resin.

In such an embodiment, the embodiment which is preferred in view of low Tg includes a polymerization-curable composition in which the organic compound contains silicone. Specific examples of the organic compound containing silicone include silicone resin powders (KMP-590, 701, X-52-854, X-52-1621, etc.), silicone rubber powders (KMP-597, 598, 594, X-52-875, etc.) and silicone composite resin powders (KMP-600, 601, 602, 605, X-52-7030, etc.). Of these organic compounds, silicone composite resin powders (KMP-600, 601, 602, 605, X-52-7030, etc.) are preferred because of excellent dispersibility in a resin and wettability with a resin.

Also in a method for polymerization-curing a polymerization-curable composition according to the above second aspect, the aspect described in the preferred embodiment with respect to the polymerization-curable composition according to the above first aspect can be appropriately applied, if necessary.

One preferred embodiment of the polymerization-curable composition according to the above third aspect includes a polymerization-curable composition in which an elastic modulus at 25° C. is 1 GPa or less. The elastic modulus at 25° C. is preferably 1 GPa or less, since flexibility can be obtained when used at around room temperature. The elastic modulus at 25° C. is not preferably more than 1 GPa, since sufficient flexibility cannot be obtained and thus fracture may easily occur because of brittleness according to the operating environment. The elastic modulus at 25° C. is more preferably from 10 mPa to 900 mPa, and particularly preferably from 50 mPa to 800 mPa.

Also in the polymerization-curable composition according to the above third aspect, the aspect described in the preferred embodiment with respect to the polymerization-curable composition according to the above first aspect can be appropriately applied, if necessary.

Examples of applications of the polymerization-curable composition according to the above first aspect include adhesives, coating materials, casting materials and the like. Of these applications, those having a large capacity such as adhesives and coating materials are preferred, because it is possible to advantageously make use of the fact that these adhesives and coating materials can be easily polymerization-cured, since the entire polymerization-curable composition is polymerization-cured by secondary thermal energy generated by applying primary thermal energy to a portion of the polymerization-curable composition.

Examples of applications of the polymerization-cured resin composition according to the third aspect also include adhesives, coating materials, casting materials and the like. Of these applications, adhesives and casting materials are preferred.

### EXAMPLES

The present invention will be described in more detail by way of Examples and Comparative Examples according to the present invention, but is not limited to the Examples. The amounts of materials used in the Examples and Comparative Examples are expressed by “gram”, unless otherwise specified.

### Examples 1 to 19, Comparative Examples 1 to 5

After weighing (i) commercially available Oxetane 1 (OXT-221, manufactured by TOAGOSEI CO., LTD.) and Oxetane 2 (OXT-121, manufactured by TOAGOSEI CO., LTD.), each having two oxetane groups, or Oxetane 3 having one oxetane group (OXT-211, manufactured by TOAGOSEI CO., LTD.) as a cationically polymerizable compound having an oxetane group as a cationically polymerizable functional group in the molecule; (ii) commercially available Vinylether 1 (TEGVE, manufactured by NIPPON CARBIDE INDUSTRIES CO., INC.) or Vinylether 2 (CHDVE, manufactured by NIPPON CARBIDE INDUSTRIES CO., INC.), each having two vinylether groups, or Vinylether 3 having one vinylether group (CHDVE, manufactured by NIPPON CARBIDE INDUSTRIES CO., INC.), or Vinylether 4 (high-molecular weight DVE1 castor oil, a compound obtained by reacting HDI (hexamethylene diisocyanate) manufactured by Asahi Kasei Chemicals Corporation with both ends of castor oil polyol manufactured by ITOH OIL CHEMICALS CO., LTD. to obtain a urethane prepolymer, and adding a monovinylether compound having an OH group (CHMVE: manufactured by NIPPON CARBIDE INDUSTRIES CO., INC.) to the isocyanate group of the urethane prepolymer), Vinylether 5 (high-molecular weight DVE2 silicone, a compound obtained by reacting HDI (hexamethylene diisocyanate) manufactured by Asahi Kasei Chemicals Corporation with a carbitol both-terminated silicone manufactured by Shin-Etsu Chemical Co., Ltd. to obtain a urethane prepolymer, and adding a monovinylether compound having an OH group (CHMVE: manufactured by NIPPON CARBIDE INDUSTRIES CO., INC.) to the isocyanate group of the urethane prepolymer) or Vinylether 6 (high-molecular weight DVE3 PTXG, a compound obtained by reacting HDI (hexamethylene diisocyanate) manufactured by Asahi Kasei Chemicals Corporation with PTXG (polyether) manufactured by Asahi Kasei Chemicals Corporation to obtain a urethane prepolymer, and adding a monovinylether compound having an OH group (CHMVE: manufactured by NIPPON CARBIDE INDUSTRIES CO., INC.) to the isocyanate group of the urethane prepolymer), each having one vinylether group, as a cationically polymerizable compound having a vinylether group as a cationically polymerizable functional group in the molecule; (iii) commercially available Epoxy 1 (2021, manufactured by DAICEL CHEMICAL INDUSTRIES, LTD.), Epoxy 2 (hydrogenated bisphenol A type, manufactured by Japan Epoxy Resins Co., Ltd.) or Epoxy 3 (bisphenol A type, manufactured by Japan Epoxy Resins Co., Ltd.), each having two alicyclic epoxy groups, as a cationically polymerizable compound having an alicyclic epoxy group as a cationically polymerizable functional group in the molecule; (iv) commercially available Reaction initiator 1 (ADEKAOPTON CP-77, manufactured by ADEKA CORPORATION), commercially available Reaction initiator 2 (SI-60L, manufactured by SANSHIN CHEMICAL INDUSTRY CO., LTD.) or commercially available Reaction initiator 3 (ADEKAOPTON SI-100L, manufactured by SANSHIN CHEMICAL INDUSTRY CO., LTD.) as a thermally latent polymerization initiator; and, if necessary, commercially available Filler 1 (SILICONE KMP-601, manufactured by Shin-Etsu Chemical Co., Ltd.), commercially available Filler 2 (SILICONE KMP-600, manufactured by Shin-Etsu Chemical Co., Ltd.) or commercially available Filler 3 (Alumina having an average particle diameter of 30 μm, manufactured by Nippon Light Metal Co., Ltd.) as a filler, in each amount (g) shown in Table 1, these components were mixed with stirring at room temperature for 2 minutes, using Awatori-NERITARO, manufactured by Thinky Co., Ltd. according to each combination shown in Table 1 to prepare polymerization-curable compositions in Examples and Comparative Examples shown in Table 1.

Cationically polymerizable compounds had chemical equivalents shown in Table 1, and polymerization-curable compositions in Examples and Comparative Examples had the concentrations (mmol/g) of a cationically polymerizable functional group based on the entire polymerization-curable composition shown in Table 1. The value described in the column of equivalents of Fillers 1 to 3 in Table 1 shows thermal conductivity (W/mK) of each filler.

Each of polymerization-curable compositions in Examples and Comparative Examples was poured into a mold measuring 100 mm in length, 10 mm in width and 2 mm in width. Using a soldering iron heated to an initial application temperature shown in Table 1 as heating means, each polymerization-curable composition was allowed to undergo an exothermic polymerization reaction by heating the portion located at 5 mm on average (temperature distribution in a longitudinal direction of a test piece was measured using a thermoviewer) from one side in a longitudinal direction of each test piece, and then polymerization curing in the longitudinal direction of the test piece of each polymerization-curable composition was allowed to proceed by secondary thermal energy generated as a result of the exothermic polymerization reaction. The polymerization curing time was from 1 to 3 minutes.

In Examples and Comparative Examples, visually confirmed chain curability, i.e. the length (cm) in the longitudinal direction of the test piece of the polymerization-curable composition in which polymerization curing proceeded by secondary thermal energy was as shown in Table 1. In Comparative Examples 1 to 4, polymerization curing by secondary thermal energy did not easily proceed, and it was difficult to measure chain curability (cm).

The elastic modulus (measured by a dynamic viscoelasticity measuring apparatus) of the polymerization-curable compositions in Examples and Comparative Examples was as shown in Table 1. In Comparative Examples 1 to 5, since polymerization curing did not easily proceed and chain curability (cm) was small, it was difficult to measure the elastic modulus of the polymerization-curable composition.

TABLE 1

| | | Examples | | | | | | | | | | | |
|---|---|---|---|---|---|---|---|---|---|---|---|---|---|
| Materials | Equivalents | 1 | 2 | 3 | 4 | 5 | 6 | 7 | 8 | 9 | 10 | 11 | 12 |
| Oxetane 1 | 107 | 80 | 80 | 80 | 80 | 80 | 80 | 80 | 90 | 95 | 95 | 95 | 80 |
| Oxetane 2 | 180 | | | | | | | | | | | | |
| Oxetane 3 | 192 | | | | | | | | | | | | |
| Vinylether 1 | 101 | 20 | 20 | 20 | 20 | 20 | 20 | | | | | | |
| Vinylether 2 | 98 | | | | | | | 20 | | | | | |
| Vinylether 3 | 156 | | | | | | | | 10 | | | | |
| Vinylether 4 | 1500 | | | | | | | | | 5 | | | |
| Vinylether 5 | 700 | | | | | | | | | | 5 | | |
| Vinylether 6 | 1500 | | | | | | | | | | | 5 | |
| Epoxy 1 | 126 | | | | | | | | | | | | 20 |
| Epoxy 2 | 200 | | | | | | | | | | | | |
| Epoxy 3 | 190 | | | | | | | | | | | | |
| Reaction initiator 1 | | 2 | 3 | 3 | 3 | | | 2 | 2 | 2 | 2 | 2 | 2 |
| Reaction initiator 2 | | | | | | 2 | | | | | | | |
| Reaction initiator 3 | | | | | | | 2 | | | | | | |
| Filler 1 | <0.2 | | 10 | 50 | | 30 | 30 | 20 | 20 | 20 | | | 20 |
| Filler 2 | <0.2 | | | | 30 | | | | | | | | |
| Filler 3 | 3 | | | | | | | | | | | | |
| Concentration of | | 9.3 | 8.4 | 6.2 | 7.1 | 7.2 | 7.2 | 7.8 | 7.4 | 7.3 | 8.8 | 8.7 | 7.4 |
| functional group | | | | | | | | | | | | | |
| (mmol/g) | | | | | | | | | | | | | |
| Initial application | | 200 | 250 | 380 | 250 | 250 | 250 | 250 | 250 | 250 | 250 | 250 | 250 |
| temperature (° C.) | | | | | | | | | | | | | |
| Chain curability | | >10 | >10 | >10 | >10 | >10 | >10 | >10 | >10 | >10 | >10 | >10 | >10 |
| (cm) | | | | | | | | | | | | | |
| Elastic modulus of | | 0.7 | 0.6 | 0.2 | 0.3 | 0.3 | 0.3 | 0.4 | 0.3 | 0.4 | 0.4 | 0.4 | 0.7 |
| cured article (GPa) | | | | | | | | | | | | | |

| | Examples | | | | | | | Comparative Examples | | | | |
|---|---|---|---|---|---|---|---|---|---|---|---|---|
| Materials | 13 | 14 | 15 | 16 | 17 | 18 | 19 | 1 | 2 | 3 | 4 | 5 |
| Oxetane 1 | 50 | 80 | 90 | | | | | 80 | 80 | 30 | | 80 |
| Oxetane 2 | | | | 60 | | | | | | | | |
| Oxetane 3 | | | | | 10 | | | | | | | |
| Vinylether 1 | | | | 40 | 40 | 30 | 30 | 20 | 20 | | | 20 |
| Vinylether 2 | | | | | | | | | | | | |
| Vinylether 3 | | | | | | | | | | | | |
| Vinylether 4 | | | | | | | | | | 70 | | |
| Vinylether 5 | | | | | | | | | | | | |
| Vinylether 6 | | | | | | | | | | | | |
| Epoxy 1 | 50 | | | | 50 | 70 | | | | | 100 | |
| Epoxy 2 | | 20 | | | | | 70 | | | | | |
| Epoxy 3 | | | 10 | | | | | | | | | |
| Reaction initiator 1 | 2 | 2 | 2 | 2 | 2 | 2 | 2 | 0.1 | 10 | 3 | 2 | 3 |
| Reaction initiator 2 | | | | | | | | | | | | |
| Reaction initiator 3 | | | | | | | | | | | | |
| Filler 1 | 20 | 20 | 20 | 20 | 20 | | | | | | | |
| Filler 2 | | | | | | | | | | | | |
| Filler 3 | | | | | | | | | | | | 50 |
| Concentration of | 7.1 | 6.9 | 7.3 | 6.0 | 6.9 | 8.4 | 6.3 | 9.4 | 8.6 | 3.2 | 7.8 | 6.2 |
| functional group | | | | | | | | | | | | |
| (mmol/g) | | | | | | | | | | | | |
| Initial application | 250 | 250 | 250 | 250 | 250 | 250 | 250 | 250 | 250 | 250 | 60 | 250 |
| temperature (° C.) | | | | | | | | | | | | |
| Chain curability | >10 | >10 | >10 | >10 | >10 | >10 | >10 | x | x | x | x | <1 |
| (cm) | | | | | | | | | | | | |
| Elastic modulus of | 0.8 | 0.6 | 0.5 | 0.4 | 0.4 | 0.9 | 0.9 | — | — | — | — | — |
| cured article (GPa) | | | | | | | | | | | | |

As shown in Table 1, it was confirmed that, in Examples 1 to 19, satisfactory chain curability is exhibited, i.e. polymerization curing proceeds in a short time by secondary thermal energy generated by an exothermic polymerization reaction caused by applying primary thermal energy to a portion of the compositions, and that the resulting polymerization-cured resin compositions have satisfactory elastic modulus.

We claim:

1. A polymerization-curable composition comprising at least one kind of a cationically polymerizable compound having in the molecule at least one cationically polymerizable functional group selected from the group consisting of an alicyclic epoxy group, a vinylether group and an oxetane group, and at least one kind of a thermally latent polymerization initiator, characterized in that the polymerization-curable composition is allowed to undergo an exothermic polymerization reaction by applying primary thermal energy to a portion of the polymerization-curable composition, and then the entire polymerization-curable composition is polymerization-cured by secondary thermal energy generated as a result of the exothermic polymerization reaction.

2. The polymerization-curable composition according to claim 1, wherein the primary thermal energy is applied to 10% by mass or less of the entire polymerization-curable composition.

3. The polymerization-curable composition according to claim 1, wherein the primary thermal energy is applied by heating the polymerization-curable composition to a temperature within a range from 100° C. to 400° C.

4. The polymerization-curable composition according to claim 1, wherein the primary thermal energy is applied by heating the polymerization-curable composition to a temperature within a range from 150° C. to 350° C.

5. The polymerization-curable composition according to claim 1, wherein at least one kind of the cationically polymerizable compound has at least one alicyclic epoxy group.

6. The polymerization-curable composition according to claim 1, wherein the concentration of the cationically polymerizable functional group is 0.5 mmol/g or more based on the entire polymerization-curable composition.

7. The polymerization-curable composition according to claim 1, wherein at least one kind of the thermally latent polymerization initiator is a sulfonium salt.

8. The polymerization-curable composition according to claim 1, wherein the additive amount of at least one kind of the thermally latent polymerization initiator is from 0.1% by mass to 5% by mass in terms of the solid content, based on the entire polymerization-curable composition.

9. The polymerization-curable composition according to claim 1, wherein the chemical equivalent of the cationically polymerizable functional group in at least one kind of the cationically polymerizable compound is 200 g/mol or more and 20,000 g/mol or less.

10. The polymerization-curable composition according to claim 1, wherein the chemical equivalent of the cationically polymerizable functional group in at least one kind of the cationically polymerizable compound is 300 g/mol or more and 10,000 g/mol or less.

11. The polymerization-curable composition according to claim 9 or 10, wherein at least one of the cationically polymerizable compound has a structural skeleton derived from polyether, silicone, castor oil or polybutadiene.

12. The polymerization-curable composition according to claim 1, further comprising 5 to 500% by mass of a filler.

13. The polymerization-curable composition according to claim 12, wherein the filler has a thermal conductivity of 1 W/mK or less.

14. The polymerization-curable composition according to claim 12, wherein the filler has a thermal conductivity of 0.5 W/mK or less.

15. The polymerization-curable composition according to claim 12, wherein the filler is an organic compound.

16. The polymerization-curable composition according to claim 15, wherein the organic compound contains silicone.

17. A method for polymerization-curing a polymerization-curable composition, which comprises supplying a polymerization-curable composition comprising at least one kind of a cationically polymerizable compound having in the molecule at least one cationically polymerizable functional group selected from the group consisting of an alicyclic epoxy group, a vinylether group and an oxetane group, and at least one kind of a thermally latent polymerization initiator; applying primary thermal energy to a portion of the polymerization-curable composition, thereby causing an exothermic polymerization reaction in the polymerization-curable composition; and polymerization-curing the entire polymerization-curable composition by secondary thermal energy generated as a result of the exothermic polymerization reaction.

18. A polymerization-cured resin composition, which is obtained by supplying a polymerization-curable composition comprising at least one kind of a cationically polymerizable compound having in the molecule at least one cationically polymerizable functional group selected from the group consisting of an alicyclic epoxy group, a vinylether group and an oxetane group, and at least one kind of a thermally latent polymerization initiator; applying primary thermal energy to a portion of the polymerization-curable composition thereby causing an exothermic polymerization reaction in the polymerization-curable composition; and polymerization-curing the entire polymerization-curable composition by secondary thermal energy generated as a result of the exothermic polymerization reaction.

19. The polymerization-cured resin composition according to claim 18, wherein an elastic modulus at 25° C. is 1 GPa or less.
